(19) United States
(12) Patent Application Publication
(10) Pub. No.: US 2015/0343920 A1
(43) Pub. Date: Dec. 3, 2015

(54) METHOD AND SYSTEM FOR CHARGING ELECTRIC VEHICLES VIA FUEL CARTRIDGE

(71) Applicant: Emrah KINAV, Istanbul (TR)

(72) Inventor: Emrah KINAV, Istanbul (TR)

(21) Appl. No.: 14/288,394

(22) Filed: May 28, 2014

(51) Int. Cl. B60L 11/18; H01M 8/04; H01M 10/44

(52) U.S. Cl. CPC B60L 11/1887; H01M 10/44; H01M 8/04208; H01M 8/04223

(57) ABSTRACT

The present invention relates to a fuel cartridge that is filled with fuel and a system for charging electric vehicles via the fuel cartridge together with internal combustion engine-generator or fuelcell that is equipped on the vehicle, by which electric vehicles can be charged in case of emergency regardless of places, times or infrastructures. A method for charging electric vehicles is also provided.

### FIELD OF THE INVENTION

The present invention relates to a system and a method for charging electric vehicles via a fuel cartridge which enables electric vehicles to be charged in emergency.

### BACKGROUND OF THE INVENTION

The popularization of electric vehicles is limited by the energy storage capacities of batteries and the development of charging infrastructure. A battery operated electric vehicle needs to go to a charging station when the battery charge is depleted. Currently, there are not many charging stations available and the charging period takes too long (up to 8-10 hours). Lack of the availability of enough charging stations causes issues in emergency situations. In current applications used in the art, an internal combustion engine propulsion system is combined with an electric propulsion system. However, these hybrid electric vehicles generally have much more complicated control mechanisms and lower economic and environmental benefits than battery electric vehicles.

### SUMMARY OF THE INVENTION

The objective of the present invention is to provide a fuel cartridge filling with certain types of fuel which can be used to charge electric vehicle at any time and any place.

Another objective of the present invention is to realize a system and a method for charging battery electric vehicles via fuel cartridge which enables electric vehicles to be charged in cases of emergency without charging infrastructure, especially when the electric vehicle is stranded.

In accordance with one embodiment of the invention, a single use of refillable fuel cartridge for storing fuel which is used to charge electric vehicles comprises a sealed valve which is capable of ensuring leak tightness and an indicator which is capable of showing the amount of fuel. The fuel cartridge can be fixed on electric vehicle externally and connecting to an internal combustion engine-generator/fuelcell disposed inside the electric vehicle.

In accordance with one embodiment of the invention, a system for charging an electric vehicle comprises:

at least one fuel cartridge filled with fuels, wherein fuel cartridge can be fixed on electric vehicle externally;
at least one internal combustion engine-generator/fuelcell which is capable of converting fuel into electric energy, wherein internal combustion engine-generator/fuelcell is disposed inside electric vehicle; and
at least one battery which is capable of storing electric energy, wherein the battery is disposed inside the electric vehicle.

A method for charging an electric vehicle, comprising the steps of:

parking the electric vehicle;
fixing at least one fuel cartridge externally to the electric vehicle and connecting the fuel cartridge with at least one internal combustion engine-generator/fuelcell configured inside the electric vehicle;
converting fuels in the fuel cartridge into electric energy;
storing the electric energy in at least one battery configured inside the electric vehicle; and
removing the fuel cartridge.

### BRIEF DESCRIPTION OF THE DRAWINGS

FIG. 1 illustrates schematic view of the system for charging an electric vehicle embodying the principle of the present invention.

FIG. 2 illustrates schematic view of the internal combustion engine-generator embodying the principle of the present invention.

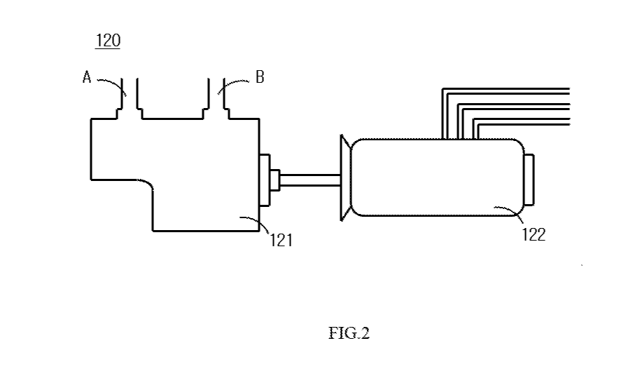

FIG. 3 illustrates schematic view of the fuel cartridge embodying the principle of the present invention.

FIG. 4 illustrates flowchart of the method of charging electric vehicles embodying the principle of the present invention.

### DETAILED DESCRIPTION OF THE INVENTION

Embodiments of a fuel cartridge, a system for charging electric vehicle via fuel cartridge, and associated processes for using such fuel cartridge to charge electric vehicle are described.

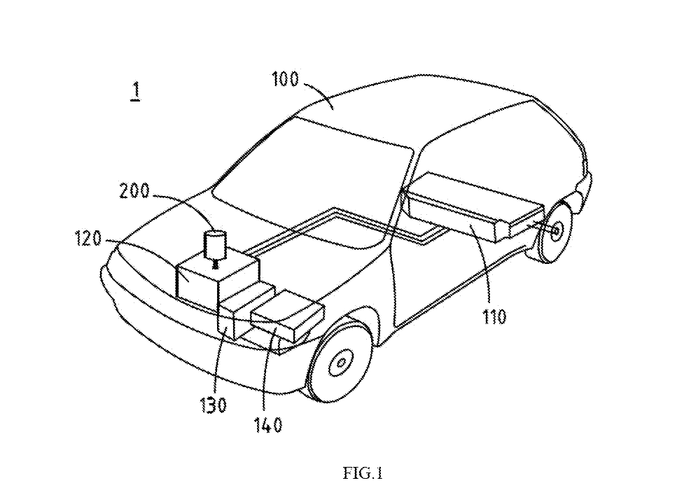

Referring to FIG. 1, the charging system 1 comprises an electric vehicle 100 and a fuel cartridge 200. Electric vehicle 100 is designed to use pure electric propulsion which comprises a battery 110, an internal combustion engine-generator 120, a control unit 130 and an electric motor 140. Electric motor 140 propels electric vehicle using the electric energy stored in battery 110. In hybrid electric vehicle, other types of propulsions besides electric propulsion may be provided employing internal combustion engine and fuel tank carried inside the vehicle. In contrast, internal combustion engine-generator 120 is used to recharge battery 110 by converting fuels into electric energy and there is no fuel tank inside electric vehicle 100. Fuel is provided to internal combustion engine-generator 120 from external fuel cartridge 200 during charge. The charge process is controlled by control unit 130 by transferring electric energy to battery 110 and controlling a fill rate of the battery 110.

Internal combustion engine-generator 120 uses an internal combustion engine (ICE) 121 connected to a generator 122 to produce electricity. ICE 122 has an intake A where fuel and oxidizer (usually air) are transported into ICE 121. The combustion of fuel occurs with air by an ignition inside ICE 121 produces high-temperature and high-pressure gases which apply direct force, transforming chemical energy of fuel into useful mechanical energy. The exhaust gas generated during combustion is discharged through outlet B. The types of ICE 121 can be two-stroke engine, four-stroke engine, Atkinson cycle, Miller cycle and etc, which is not limited. Generator 122 converts mechanical energy generated by ICE 121 to electrical energy. The electrical energy is transmitted and stored in battery 110. The type of generator is also not limited and can be configured according to dynamic driving needs. Internal combustion engine-generator 120 does not connect to tires for providing propulsion directly but only generates electrical energy to feed to battery.

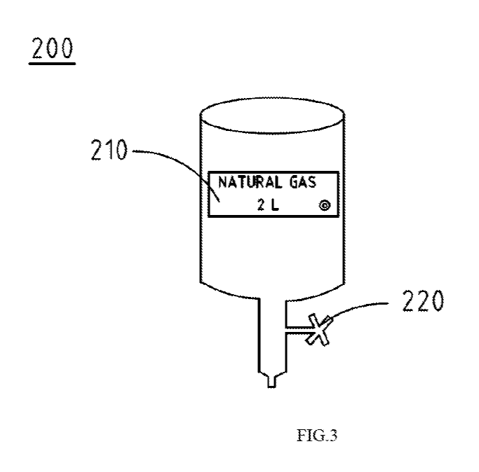

Fuel cartridge 200 can be fixed on the electric vehicle 100 externally as needed and removed after charging. Fuel cartridge is filled with different amounts and types of fuel to suit the capabilities and requirements of various electric vehicles 100 with various internal combustion engine-generators 120 inside. Referring to FIG. 3, fuel cartridge 200 comprises an indicator 210 showing the amount of fuel. Besides, it is possible to use different types of fuel with fuel cartridge 200 designed in different colors or different sizes for easy perception. The type of fuel can be natural gas, hydrogen, liquefied petroleum gas, and etc.

The fuel cartridge 200 further comprises a sealed valve 220 which is capable of emitting a sound for indication when fuel cartridge 200 connects to internal combustion engine-generator 120 and ensuring leak tightness of the connection. Fuel cartridge 200 can be connected to internal combustion engine-generator 120 directly or by an adaptor.

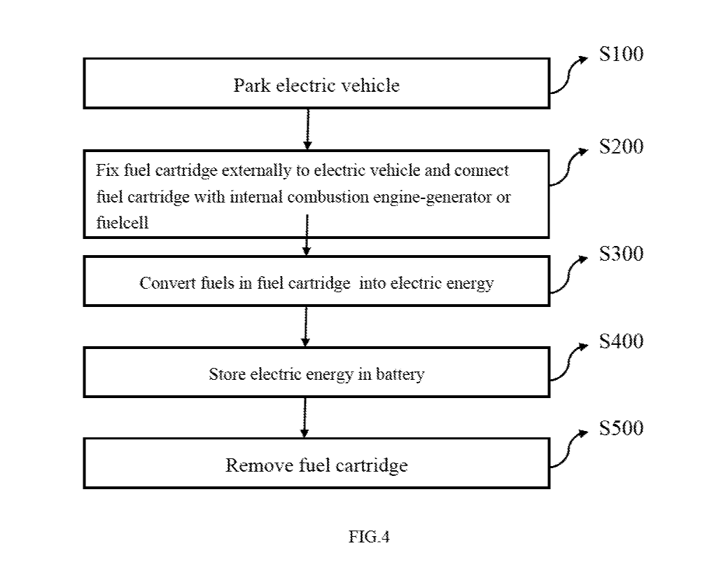

A method for charging electric vehicle 100 employing the system described above is also provided. The method comprises the steps referring to FIG. 4:
S100: parking electric vehicle 100;
S200: fixing at least one fuel cartridge 200 externally to electric vehicle 100 and connecting fuel cartridge 200 with at least one internal combustion engine-generator 120 configured inside electric vehicle 100;
S300: converting fuels in fuel cartridge 200 into electric energy;
S400: storing electric energy in at least one battery 110 configured inside electric vehicle 100;
S500: removing fuel cartridge 200.

Electric vehicle 100 can be charged in parking area, garage or other places without charging infrastructure. Then, fuel cartridge 200 is fixed on electric vehicle 100 externally and connected to internal combustion engine-generator 120 directly or via an adaptor. Sealed valve 220 can be used to insure the leak tightness between fuel cartridge 200 and the internal combustion engine-generator 120 and at the same time emit a sound to indicate that fuel cartridge 200 has been connected to internal combustion engine-generator 120 correctly.

Internal combustion engine-generator 120 converts the fuel in fuel cartridge 200 into electric energy and the electric energy is stored in battery 110. The transfer of electricity generated by internal combustion engine-generator 120 to battery 110 is controlled by control unit 130. To be more specific, control unit 130 determines the amount of required charging, controls the fill rate of battery 110, measures the electricity stored in battery 110 and stops the electricity when the stored electricity has reached a certain level.

Combustion engine-generator can be replaced with fuelcell which converts the chemical energy from a fuel into electricity through a chemical reaction with oxygen or another oxidizing agent. Since the charging via fuel cartridge and internal combustion engine-generator/fuelcell can be fast charging compared with slow charging by most of the charging stations or infrastructure, fuel cartridge can be used in case of emergency. At the end of the charging process, the connected fuel cartridge is removed and thus, there is no fuel left on the vehicle when it goes back to the road, which does not increase the weight of vehicle and at the same time offers the benefit of cleanliness and safety.

A supply and market system of fuel cartridge is provided. Fuel cartridges are standardized on fuel types, capacity, appearance and so on, which can also be designed as single-use or refillable. Then, fuel cartridges are sold full of fuel at any available gas station, retail area or fuel cartridge sales point that does not need any special infrastructure. It is possible for a buyer to buy fuel cartridges according to the amount of fuel required to cover the distance he plans to travel. The fuel cartridge is bought and used to charge the electric vehicle immediately or can be carried in the electric vehicle for a short period of time based on actual demand.

With the use of external fuel cartridge together with internal combustion engine-generator/fuelcell, an electric vehicle can be charged in cases of emergency which is no longer limited by time, places or facility.

Although the invention has been described and illustrated in detail, it is to be clearly understood that the same is intended by way of illustration and example only and is not to be taken by way of limitation. Accordingly, variations and modifications of the present invention will be apparent to one skilled in the art, and the following claims are intended to cover all such modifications and equivalents.

I claim:

1. A single use or refillable fuel cartridge for storing fuel which is used to charge electric vehicles, the fuel cartridge comprising:
a sealed valve which is capable of ensuring leak tightness and an indicator which is capable of showing amount of the fuel;
wherein the fuel cartridge is capable of being fixed on the electric vehicle externally and connecting to an internal combustion engine-generator or fuelcell disposed inside the electric vehicle.

2. The fuel cartridge according to claim 1, wherein the fuel is natural gas, hydrogen or liquefied petroleum gas.

3. The fuel cartridge according to claim 2, wherein the type of fuel is indicated by defining colors of the fuel cartridge.

4. A system for charging an electric vehicle comprising:
at least one fuel cartridge filled with fuel, wherein the fuel cartridge is fixed on the electric vehicle externally only when charging is required;
at least one internal combustion engine-generator or fuelcell which is capable of converting the fuel into electric energy, wherein the internal combustion engine-generator or fuelcell is disposed inside the electric vehicle; and
at least one battery which is capable of storing the electric energy, wherein the battery is disposed inside the electric vehicle.

5. The system according to claim 5, further comprising a control unit which is capable of transferring the electric energy to the battery and controlling a fill rate of the battery.

6. The system according to claim 5, wherein the fuel cartridge is connected to the internal combustion engine-generator or fuelcell directly or via an adaptor.

7. The system according to claim 5, wherein the fuel cartridge comprises a sealed valve which is capable of ensuring leak tightness between the fuel cartridge and the internal combustion engine-generator.

8. The system according to claim 5, wherein the fuel is natural gas, hydrogen or liquefied petroleum gas.

9. A method for charging an electric vehicle, comprising the steps of:
parking the electric vehicle;
fixing at least one fuel cartridge externally to the electric vehicle and connecting the fuel cartridge with at least one internal combustion engine-generator or fuelcell configured inside the electric vehicle;
converting fuels in the fuel cartridge into electric energy;
storing the electric energy in at least one battery configured inside the electric vehicle; and
removing the fuel cartridge.

10. The method according to claim 10, further comprising controlling an amount of the electric energy and controlling a fill rate of the battery.

11. The method according to claim 10, further comprising using a sealed valve to ensure leak tightness between the fuel cartridge and the internal combustion engine-generator or fuelcell.

12. The method according to claim 1, wherein the fuel is natural gas, hydrogen or liquefied petroleum gas.
